(19) United States
(12) Patent Application Publication
(10) Pub. No.: US 2018/0333879 A1
(43) Pub. Date: Nov. 22, 2018

(54) SPACER FOR RAZOR BLADE WITH VIBRATION

(71) Applicants: Blake Squires, Akron, OH (US); John D. Osher, Fort Lauderdale, FL (US)

(72) Inventors: Blake Squires, Akron, OH (US); John D. Osher, Fort Lauderdale, FL (US)

(21) Appl. No.: 15/985,184

(22) Filed: May 21, 2018

Related U.S. Application Data
(60) Provisional application No. 62/508,540, filed on May 19, 2017.

(51) Int. Cl. B26B 21/42; B26B 21/40; B26B 21/38

(52) U.S. Cl. CPC B26B 21/42; B26B 21/38; B26B 21/4037

(57) ABSTRACT

A razor blade assembly with a vibration feature includes a head having a blade assembly having one or more cutting blades connected to a handle. The head has a spacer to space the cutting blades from a user's skin and to create and maintain a 5 o'clock shadow beard or a stubble beard. The handle houses a vibration mechanism which is operated by a motor to cause vibration of at least one of the head and the handle.

### CLAIM OF PRIORITY

This application claims priority from Provisional Patent Application No. 62/508,540, filed on May 19, 2017, the entirety of which is hereby incorporated by reference.

### BACKGROUND OF THE DISCLOSURE

The present exemplary embodiment relates to razor blades for shaving. More particularly, it relates to a razor which has a blade that can adjusted or spaced from the user's skin to create and maintain a “5 o'clock shadow” or a “stubble” appearance without the need to grow a beard and then shave it off every several days. The razor also uses a vibration to facilitate the cutting of the facial hair to achieve the “5 o'clock shadow” or “stubble” shave.

Existing disposable razors employ fixed blades which have a predetermined depth to obtain a “clean shave”. Electric trimmers, on the other hand, often employ mechanisms by which to adjust the trimmer depth to obtain a desired depth or hair length.

In today's society, some of the most common and popular shaved appearances are shown in FIG. 1: A clean shave (CS), A “5 o'clock shadow” (SH) with a small amount of facial hair, a stubble shave (ST), and a bearded shave (BE) with a greater amount of facial hair. A stubble shave (ST) has slightly more hair than the “5 o'clock shadow” shave. In the last ten years or so, it has become extremely popular for men, particularly young men between the ages of 18-34 such as actors, models, athletes, musicians, celebrities, etc. to sport a “5 o'clock shadow” or a “stubble” appearance where they have a slight amount of facial hair that is always carefully groomed in appearance.

A problem with maintaining this look is it requires the man to grow a beard for three or four days and then shave it off every few days, and let it start to grow back until the desired appearance is achieved. This can be time consuming and frustrating for the man to maintain a consistent and carefully groomed 5 o'clock shadow or a stubble appearance.

Another problem with maintaining a 5 o'clock shadow look or a “stubble” look is there is currently no existing low cost option is to create these appearances such as by using a manual razor. Rather, an electric trimmer could possibly create a look similar to the “5 o'clock shadow” or a “stubble” appearance; however, electric trimmers are costly with no lower cost alternative available. Also, electric trimmers may not be able to provide a wide range of consistent “5 o'clock shadow” shaves or “stubble” shaves. Another problem with electric trimmers is they may apply too much pressure to the skin resulting in “bald spots” on the user's face if they shave the user's face too closely.

Vibration being used with razors is a concept that has been around for may years. For example, referring to U.S. Pat. No. 5,299,354, assigned to Gillette®, and hereby incorporated by reference, wet shave razors have employed battery powered motors to transmit an oscillating or vibration motion to a blade cartridge for desensitizing the facial nerves from the discomfort of shaving.

Another example is shown in U.S. Published Patent Application No. 2008/0155831, assigned to Procter & Gamble® and incorporated by reference herein. In this example, a motor is housed adjacent to the head and reciprocates a blade, vibrates the head, activates dispensing of shaving fluid, or oscillates a support platform.

Still another example is shown in U.S. Published Patent Application No. 2007/0500995 incorporated by reference herein. This example shows the handle has a grip portion having a battery and vibration motor mounted therein to control vibration frequency of the blade cartridge.

Furthermore, beard and electric trimmers sometimes use vibration to achieve close shaves. A problem however with these trimmers is they may apply too much pressure to the skin and create “bald spots” on the user's face and neck.

However, none of these references teach the concept of using a vibration feature with a manual razor along with a cap, spacer or adjustable guard to create and maintain a “5 o'clock shadow” or “stubble” shave.

When a user manually shaves their face and skin, they tend to pull the razor blade across the skin at a slow speed.

By adding vibration to the razor, in either the handle or the head, this shaving process is aided and enhanced and facilitates cutting the hair at a faster speed and more efficient manner. Also, by manually pulling the vibrating razor across the skin the pressure can be regulated thereby avoiding the above mentioned “bald spots”.

Thus, there is a need for a manual, low cost shaving device whereby a blade depth can be easily created and maintained by a replaceable cap or spacer or an adjustable guard or a permanent spacer or guard which is attached to a razor blade which also includes a vibration feature to easily create and consistently maintain a “5 o'clock shadow” appearance or a “stubble” shave appearance.

### SUMMARY OF THE DISCLOSURE

The present disclosure relates to razor blades. More particularly, it relates to a cap or spacer which is used to adjust the blade depth by spacing the blade from the user's skin to create and maintain a consistent “5 o'clock shadow” or a “stubble” shave appearance.

In accordance with a preferred embodiment of the disclosure, a razor blade assembly includes a handle; a head having a cutting blade assembly having one or more cutting blades connected to the handle; and the head has a spacer to create and maintain a “5 o'clock shadow” preferably in the range of 0.1 mm to 0.4 mm in thickness. An optimum thickness is preferably 0.35 mm thickness.

In accordance with a preferred embodiment of the disclosure, a razor blade assembly includes a handle; a head having a blade assembly having one or more blades connected to the handle; and a spacer or cap which is mounted to and positioned over the head and is adjusted to create and maintain a “stubble” shave such as between about 0.45 mm to 1.25 mm in thickness.

Thus, in accordance with one embodiment of the disclosure, a razor blade is provided with adjustable guards which can be permanently or removably attached to a blade receiver portion of a razor thereby controlling or otherwise limiting the depth of the blade relative to a shaving surface to form a shadow or stubble shave.

In another embodiment of the disclosure, a razor blade assembly is provided with a vibration feature having a head having a blade assembly including one or more cutting blades connected to a handle. The head has a spacer to space the one or more cutting blades from a user's skin and to create and maintain a 5 o'clock shadow beard in the range of 0.1 mm to 0.4 mm in thickness. The handle houses a vibration assembly to cause vibration of at least one of the head and the handle. A motor operates the vibration assembly.

In accordance with another embodiment of the disclosure, provided is a method of creating and maintaining a shave appearance on the skin of a user using vibration; having the steps of providing a manual razor blade assembly having a head having blades; providing a spacer which is mounted to and positioned over said head to space the blades from the skin to create and maintain a 5 o'clock shadow shave appearance in the range of 0.1 mm thickness to 0.4 mm thickness; and providing a handle having a vibration mechanism housed therein for providing vibration to at least one of the head and the handle.

In accordance with another embodiment of the disclosure, the spacers and guards for the razor blades can create and maintain a close “5 o'clock shadow” appearance in the range of about 0.1 mm to 0.4 mm in beard thickness.

The spacers or guards of the razor blades can also create and maintain a “stubble” shave appearance in the range of about 0.4 mm to 1.25 mm in beard thickness.

In accordance with another embodiment of the disclosure, a vibrating feature is included with the razor for vibration of the handle or the blade cartridge to further enhance the cutting of the hair in half to achieve a “5 o'clock shadow” or “stubble” shave in a faster and more efficient manner.

In accordance with another embodiment of the disclosure, the vibration feature is provided by a battery and motor housed within the handle razor.

In accordance with another embodiment of the disclosure, the razor blade and cap or guard can be used in a dry shave scenario wherein no creams are used since the blade does not actually contact the skin.

In accordance with another embodiment of the disclosure, the blade spacer or guard can be adjusted to fit on virtually any commercially available razor blade.

In accordance with another embodiment of the disclosure, a razor blade kit is provided which includes a razor handle, blades, and interchangeable caps or guards of various thickness dimensions.

In accordance with another embodiment of the disclosure, the caps or guards can be removably attached such as being snapped and or clicked onto the blade body.

In accordance with another embodiment of the disclosure, the razor cap or guards can be used with cream, oil, foam or lotion to form a very close shave such as 0.1 mm.

In accordance with another embodiment of the disclosure, a razor blade with an integral spacer or cap which is disposable after use can be provided.

Still other aspects of the disclosure will become apparent upon a reading and understanding of the following detailed description.

### BRIEF DESCRIPTION OF THE DRAWINGS

FIG. 1 illustrates a man with a close shave, a “5 o'clock shadow” shave, a “stubble” shave and a bearded shave;

FIG. 2 is a top plan view of a razor blade and handle assembly and a cap in accordance with one embodiment of the disclosure;

FIG. 3 is a top plan view of a carrying case and razor blade and cap in accordance with another embodiment of the disclosure;

FIG. 4 is a top plan view of a handle, blades and caps in accordance with another embodiment of the disclosure

FIG. 5 is a perspective view of a blade cap positioned over a blade cutting edge in accordance with another embodiment of the disclosure;

FIG. 5A is a cross-sectional view taken along line 5A of FIG. 5;

FIG. 6 is a bottom plan view of the blade cap of FIG. 5;

FIG. 7 is a top plan view of the cap of FIG. 5;

FIG. 8 is a rear elevational view of the cap of FIG. 5;

FIG. 9 is side elevational view of the cap of FIG. 5;

FIG. 10 is a bottom plan view of the cap of FIG. 5;

FIG. 11 is a front elevational view of the cap of FIG. 5;

FIG. 12 is a top plan view of a cap with angled ribs at a 45 degree angle in accordance with another embodiment of the disclosure;

FIG. 13 is a top plan view of a cap with angled ribs at a 60 degree angle in accordance with another embodiment of the disclosure;

FIG. 14 is a perspective view of a cap installed on a razor blade in a storage position in accordance with another embodiment of the disclosure;

FIG. 15 is a perspective view of the cap installed on a razor blade in an in-use position in accordance with another embodiment of the disclosure;

FIG. 16 is a perspective view of a razor having a guard and a vibration activator button with a vibration component housed therein in accordance with a preferred embodiment of the disclosure;

FIG. 17 is a bottom plan view of the razor assembly of FIG. 16;

FIG. 18 is a perspective view of a head and hinged spacer of the razor of FIG. 16;

FIG. 19 is a top plan view of the razor assembly of FIG. 16;

FIG. 20 is a top plan view of the internal components of the razor of FIG. 16;

FIG. 21 is a side elevational view of the internal components of FIG. 20.;

FIG. 22 is a side elevational view of the head and the vibrating mechanism of the razor of FIG. 16; and

FIG. 23 is a front elevational view of the razor of FIG. 16.

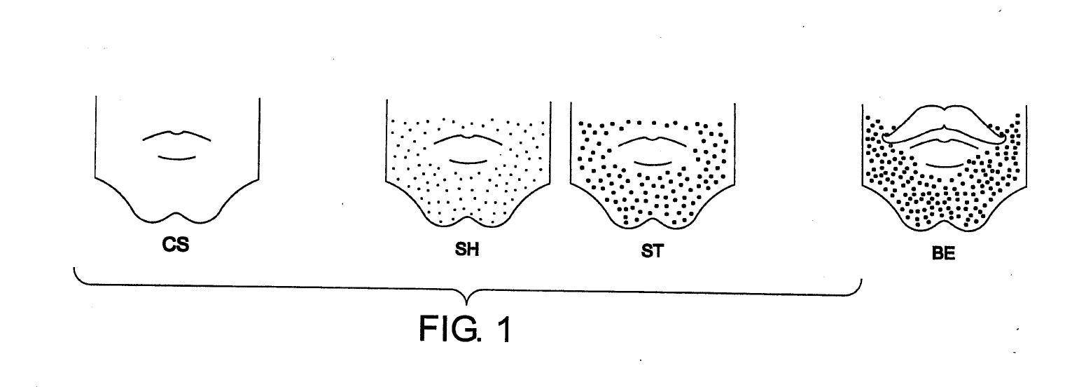

### DETAILED DESCRIPTION OF THE DISCLOSURE

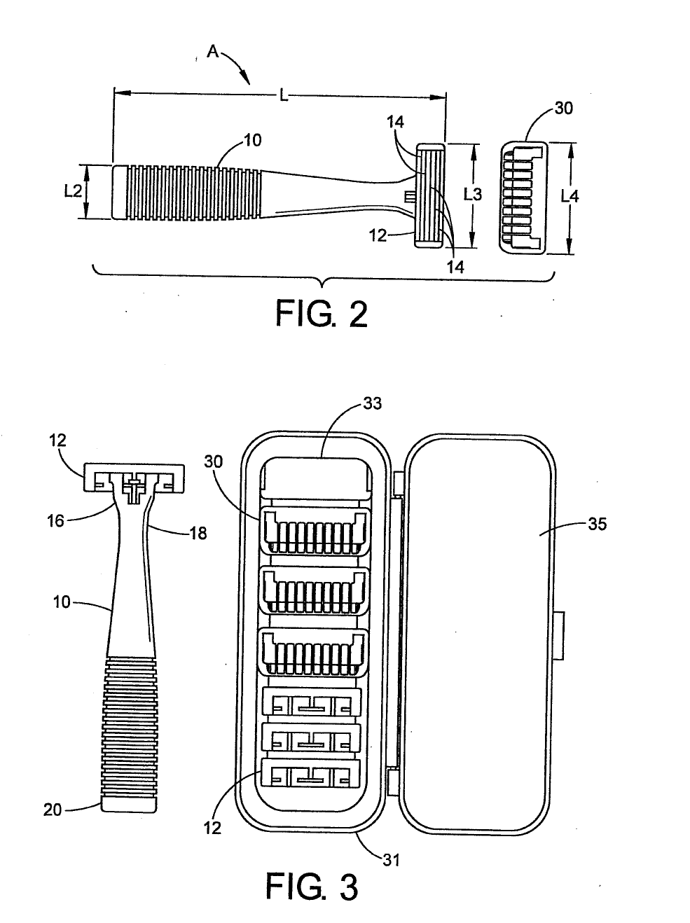

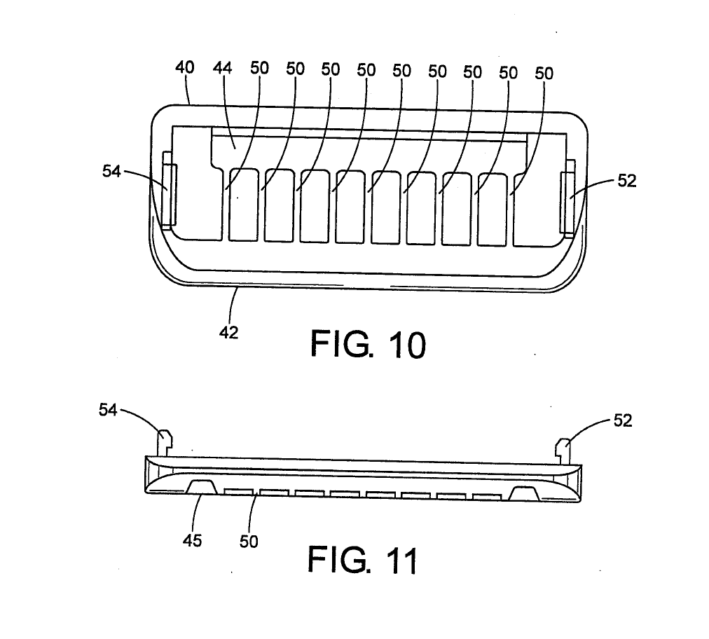

With reference now to FIGS. 2-11, 14 and 15, a preferred embodiment of a razor blade cap is shown and described. The Figures illustrate a preferred embodiment of the disclosure only is not limited to the embodiments of the Figures. Variations and modifications are contemplated by the disclosure.

Referring to FIG. 2, a disposable razor blade assembly A includes a handle 10 and a head 12 which receives razor blade(s) 14. The blade head is preferably snapped into and locks into the upper end of the handle using tabs 16 (FIG. 3) or other locking mechanisms may be snapped or moved to engage and disengage the blade head 12 from the handle 10.

The handle 10 may be rectangular or cylindrical in conformation and may taper from a narrow end 18 adjacent the blade head to a wider end 20 for gripping comfort.

Referring to FIG. 2, various dimensions for the razor blade assembly are contemplated. For example, the length L of the handle can be about 134 mm and length L2 of the wide end 20 may be about 22 mm. The blade head itself can be about 0.40 mm long (L3). One embodiment of a cap or spacer 30 preferably has a length L4 of about 0.45 mm.

Referring now to FIG. 3, a carrying case 33 such as with a clam-shell style plastic housing 31 with a hinged cover 35 is shown which can for example conveniently house the razor blade handle 10, three blade heads 12, and three or more caps 30, 32, 34.

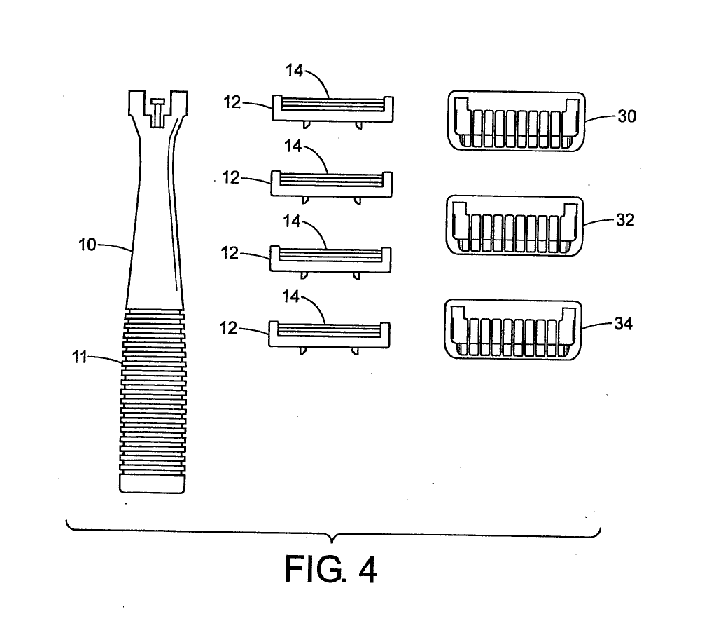

FIG. 4 illustrates the handle 10 which may have ridges or knurls 11 forming an improved ergonomic design for easy gripping, the blade heads 12, and three caps 30, 32, 34 of various gauges.

The caps can be provided in the same gauge or in different gauges. “Gauge” refers to the thickness of the desired shave; e.g., a 0.1 mm gauge refers to a 0.1 mm thickness beard, etc. As an example, cap 30 has gauge or thickness of 0.1 mm, cap 32 has a gauge of 0.2 mm, while cap 34 has a gauge of 0.4 mm. Other caps can have a gauge of 0.35 mm, etc. Many other gauges particularly in the range of 0.1 mm to 0.4 mm are contemplated by the disclosure to form a “shadow” shave.

For example, for a “5 o'clock shadow” shave, the 0.1 mm gauge cap 30 results in approximately a 0.1 mm thick beard since it spaces and positions the blades approximately 0.1 mm from the skin, the 0.2 mm gauge cap 32 provides an approximately 0.2 mm thick beard, while a 0.4 mm gauge cap 34 provides approximately a 0.4 mm thick beard, and so on. An optimum “shadow” beard thickness would be around 0.35 mm thickness.

For a stubble shave, cap 30 would have a gauge of 0.45 mm, cap 32 would have a gauge of 0.85 mm, while cap 34 would a gauge of 1.25 mm. Of course, many other gauges are contemplated by the disclosure.

The 0.45 mm gauge cap preferably results in a 0.45 mm thick stubble beard since it spaces and positions the blades approximately 0.45 mm from the skin, the 0.85 mm gauge cap provides approximately a 0.85 mm thick stubble beard, while a 1.25 mm gauge cap provides approximately a 1.25 mm thick stubble beard. The caps can be made of any suitable material, such as plastic or metal but slightly flexible plastic is preferred. The caps can be made from molds, extrusions or any suitable manufacturing method.

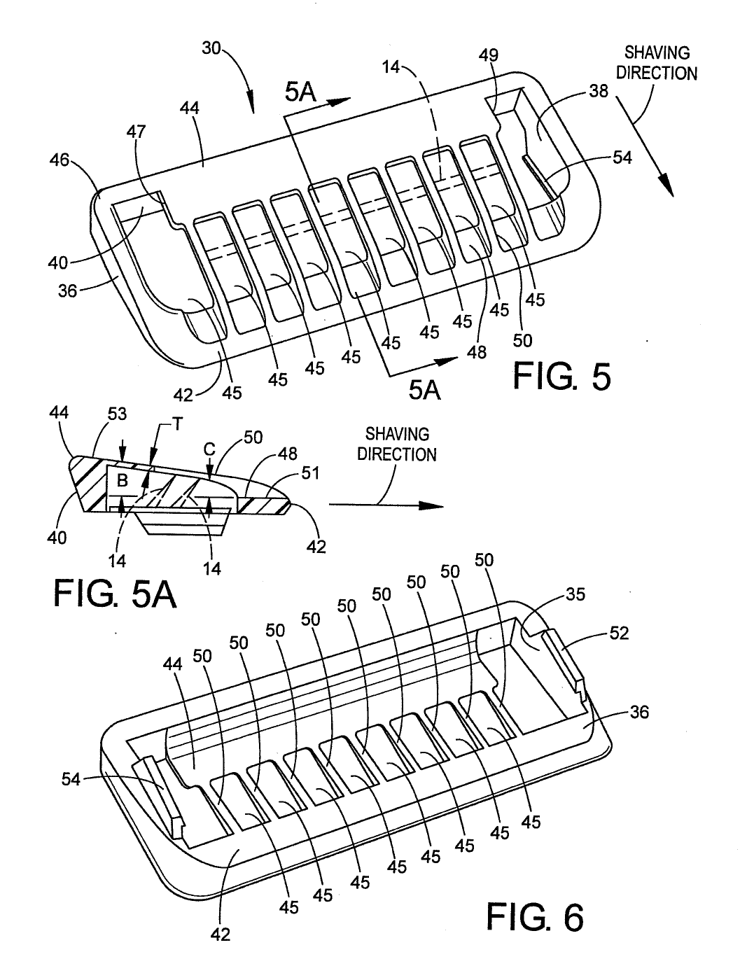

Referring now to FIGS. 5-11, the details of a preferred embodiment of cap 30 are shown and explained. Other caps 32, 34 will have essentially the same features except for the gauge or thickness. The cap has two side walls 36, 38 which are parallel to each other, a first or back wall 40 which is perpendicular to side walls 36, 38. A second or front wall 42 extends between walls 36, 38 and is perpendicular to walls 36, 38.

Side walls 36 and 38 are preferably tapered or angled resulting in wall 44 being positioned at an angle or slightly above wall 42. A plurality of cavities 45 are formed between walls 36, 38, 40, 42 and between ribs 50. An extension or top wall 44 extends from an upper end 46 of wall 40 between walls 36, 38, while a second extension or bottom wall 48 extends from bottom wall 42 between walls 36, 38. The protrusion walls 44, 48 add rigidity and may also aid in mounting the cap to the blade head. Wall 44 may also have wings or curved edges 47, 49 for added rigidity.

Wall 48 serves as a facial hair receiving or entry surface. Referring to FIG. 5A, surface 51 of wall 48 is spaced or positioned below surface 53 of wall 44 by dimension “B” and below an upper cutting edge 55 of a cutting blade 14 by dimension “C”. This allows the hair to be cut to not bend or get crimped by the edge of the cap and align the hair with and be engaged by the cutting edges 55 of blade 14. The ribs or facial hair guides 50 engages the skin of the face of the user, and serves to space the surface to be shaved from the blade cutting edge 55 to result in a specific hair length (referred to as gauge thickness). The shaving direction is shown in FIGS. 5 and 5A.

The wall 44 can serve as a stop surface for preventing further cutting and also to facilitate removal of the cut hair from the face of the user.

Several ribs or facial hair guides 50 extend between and connect wall 44 and wall 48. The ribs may be chamfered and tapered between walls 44 and 46. Nine ribs are shown, but other numbers are contemplated by the disclosure. The ribs are shown as substantially equally spaced, but other spacing is contemplated by the disclosure. The ribs are substantially parallel to each other and form a grid and due to the thickness T of the ribs serve as a spacer for spacing the cutting edge 55 of the blade 14 from the user's skin. That is, the blades cutting edges are positioned below the ribs. Thus, the thicker the ribs, the thicker (i.e., higher gauge) the shave (i.e., the hair is longer). The thinner the ribs (i.e., lower gauge), the closer the shave (i.e., the hair is shorter). In this example, the ribs have a thickness T of about 0.1 mm to form a 0.1 mm thick beard which is referred to as a “5 o'clock shadow”.

The ribs 50 of the cap thus are able to create and maintain a certain thickness of shave, commonly referred to as a “5 o'clock shadow”. The optimum thickness for a 5 o'clock shadow appearance is in the range of 0.1 mm to 0.4 mm in thickness. Thus, the various thickness T of the ribs can be about 0.1 mm, 0.2 mm, 0.3 mm and 0.4 mm. Other thicknesses are contemplated by the disclosure.

The ribs 50 of the cap thus are able to create and maintain a certain thickness of shave, commonly referred to as a “stubble shave”. The optimum thickness for a “stubble” shave appearance is in the range of 0.45 mm to 1.25 mm in thickness. Thus, the various thickness T of the ribs can be about 0.45 mm, 0.85 mm, 1.25 mm. Other thicknesses are contemplated by the disclosure.

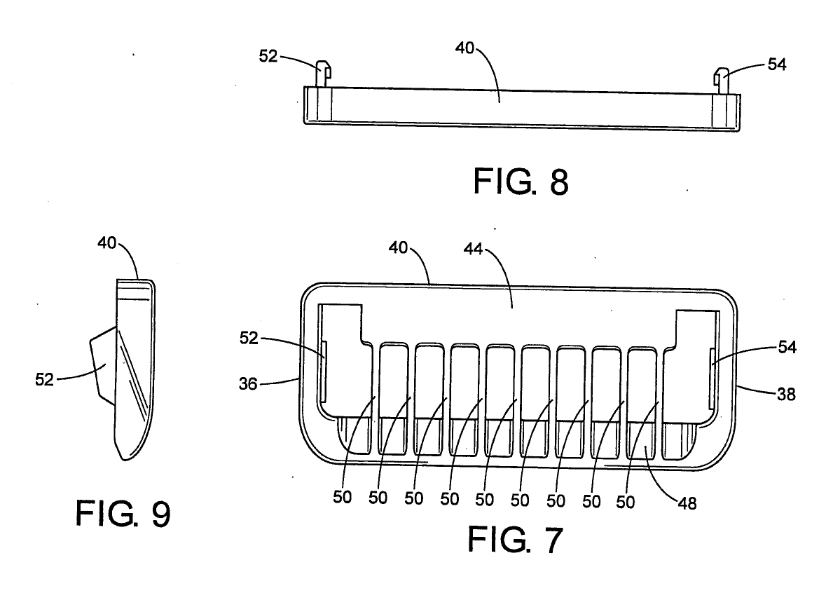

The caps 30, 32, 34 have a gauge thickness ranging from 0.1 mm to 0.4 mm to create a “5 o'clock shadow” or 0.45 mm to 1.25 mm to create a “stubble” shave. The caps can have various size grills and various numbers of ribs and may be configured to fit various blades such as two, three, four, five or six blades. FIGS. 7-11 show various views of the structure of the cap 30.

Two resiliently biased clips 52, 54 are formed on and protrude from opposite side walls 36, 38 for removably attaching the cap onto a blade by snapping or clicking the cap onto the sides of the blade head. The clips are slightly flexed outwardly and snap into place to retain the clip onto the blade itself. As an alternative, the cap can be formed as part of the head itself to provide a complete integral and disposable unit.

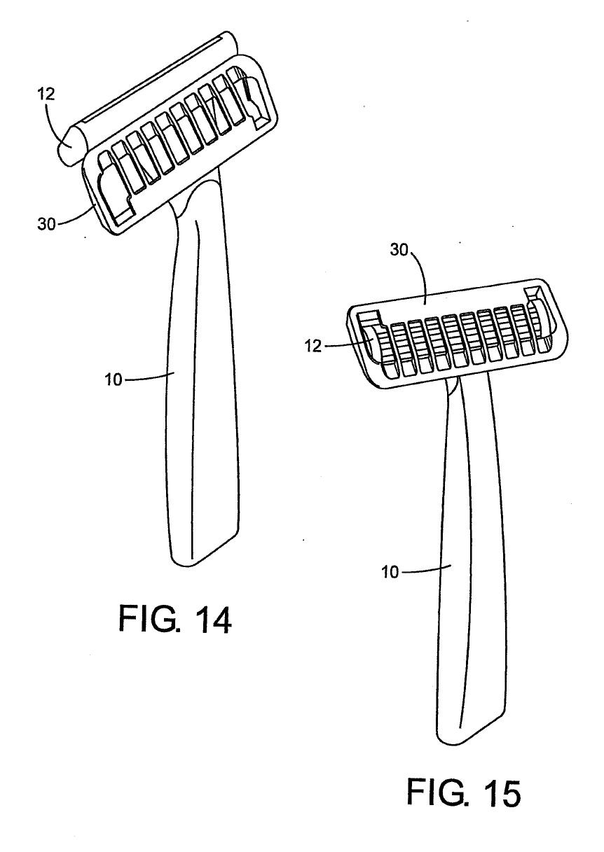

By placing the cap directly on the blade head 12 directly above blades 14 (see FIG. 15), various thicknesses of shave can be easily obtained. Thus, is no longer a need to grow a beard for one to three days and then shave it off and repeating the process to maintain the “5 o'clock shadow” look or to maintain the “stubble” look. The cap of the preferred embodiment allows the user to easily and uniformly and consistently create and maintain these looks with either a manual, disposable razor or an electric trimmer. Referring to FIG. 14, the cap 30 may be snapped or removably secured to the rear of the blade head in an in-storage position.

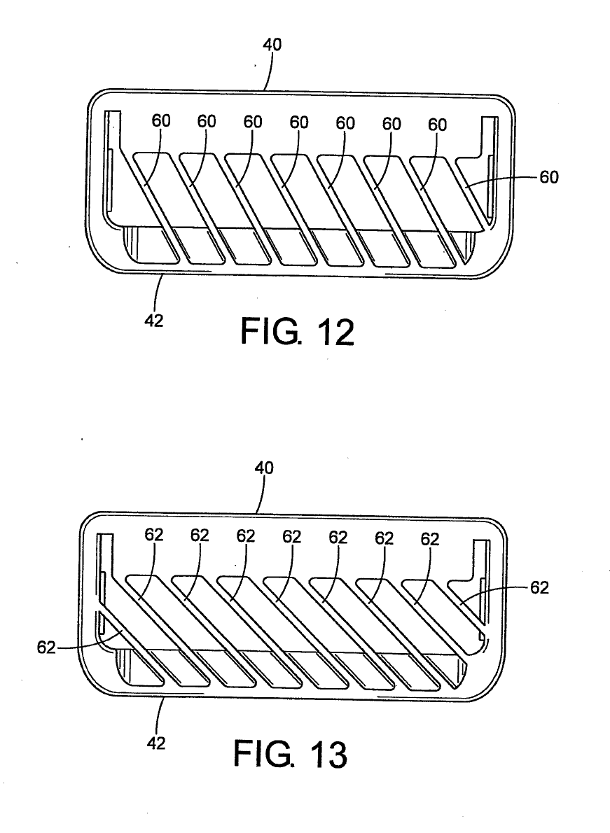

Referring to FIG. 12, in accordance with another embodiment of the disclosure, the ribs 60 may be angled at 45 degrees with respect to walls 40, 42. Referring to FIG. 13, the ribs 62 may be angled at 60 degrees with respect to walls 40, 42. By angling the ribs, a smoother shave may occur and possible bald spots can be minimized on the user's face.

The caps can be provided separately, as a disposable, and as well as with a variety of item commercially available razors, such as Gillette®, Harry's®, Schick®, Dollar Shave Club®, etc. and can also be provided with the razor and blade.

The cap can also be provided directly on the blade head or can be formed as part of the blade head for a particular gauge beard thickness as a complete, disposable unit including the blade head and handle. The cap also can be removable and reusable.

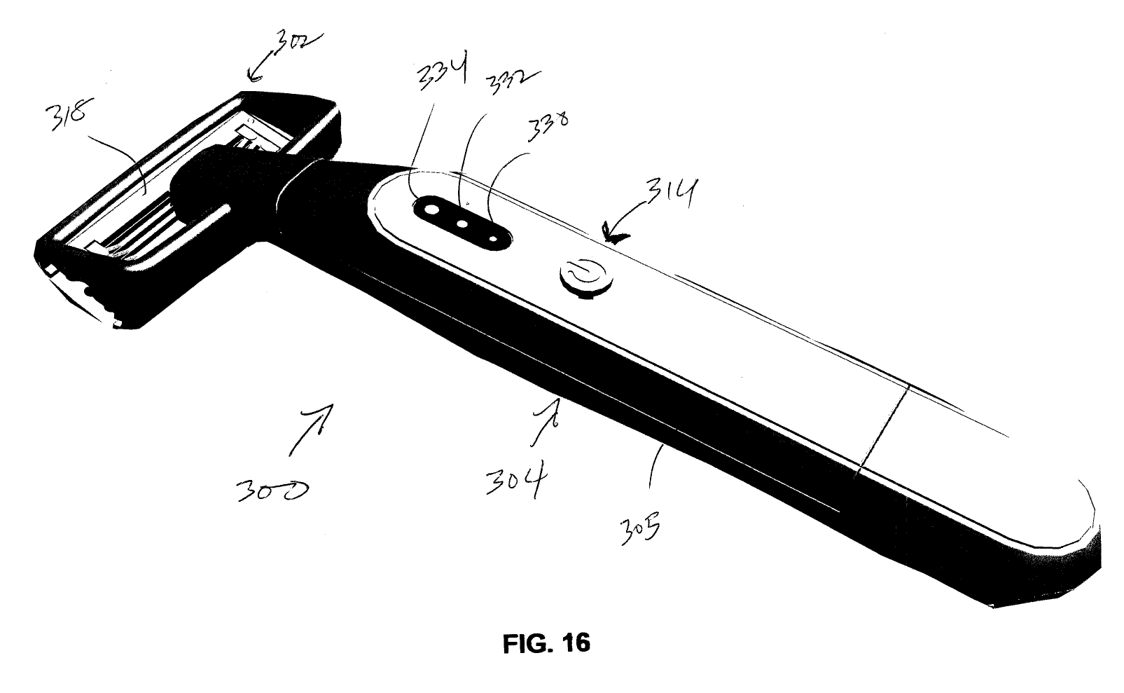

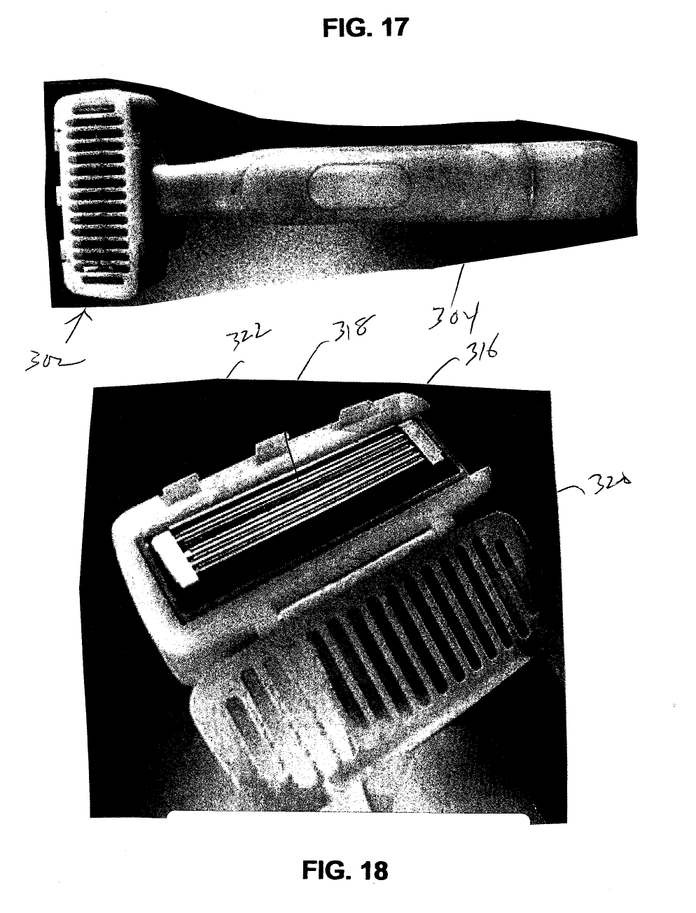

Referring now to FIGS. 16 and 17, a razor assembly 300 has a spacer or guard 302, such as those described above with reference to FIGS. 2-15, which is mounted to head 318, and has a handle 304 having a vibration actuator button 314. Referring to FIG. 16, activation button 314 may be depressed several times to increase or decrease the amount of vibration as indicated by a series of lights or LEDs 330, 332, 334 which illuminate depending on the amount of vibration preferred.

FIG. 18 shows that the spacer or guard assembly 302 can have a first member 316 which snaps onto or otherwise is secured onto razor head 318 and a second member 320 which is hingedly attached to first member 316 via hinge 320 to swing out of the way to allow access to the head member 318. Member 320 is snapped into place onto tabs 322 formed on member 316.

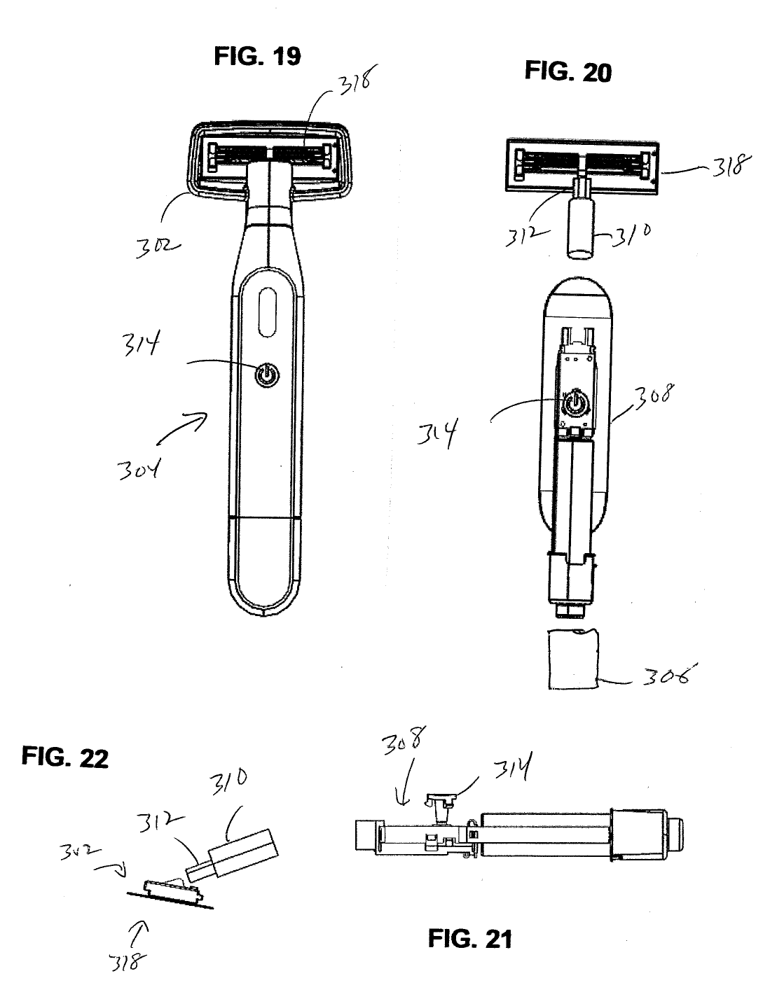

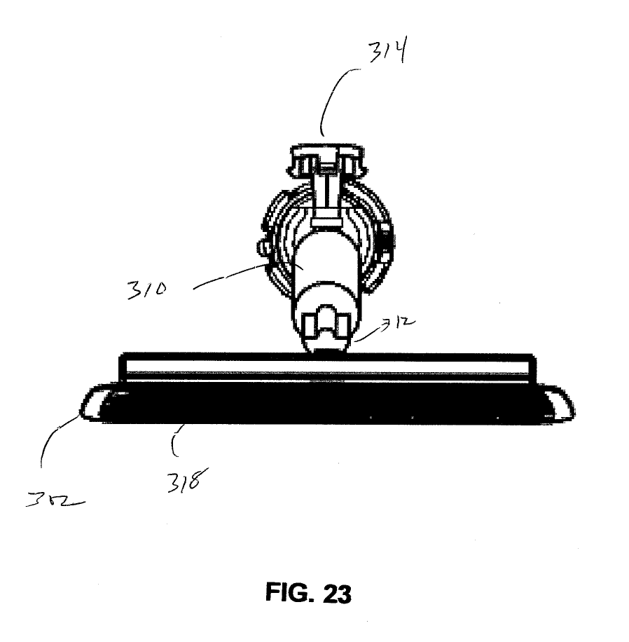

Referring now to FIGS. 19-23, the internal components of the razor assembly are shown and described. Within handle housing 304 is an activator button assembly 314 which is connected to a PCM motor 308. The motor in turn is powered by one or more batteries 306 or other powering device.

Vibration components 310 and 312 are in turn operably connected to motor 308. Vibration component 310 which is a weight made of metal or possibly plastic spins during operation which when contacting plastic housing 305 of the handle 304 causes vibration. Component 312 which is in contact with the razor head 318 and causes the blade head 318 to vibrate. Thus, the vibrating components 310 and 312 provide vibration to the head and the handle as a result of rotation or a spinning component 310. Alternately, vibration can be provided to only the head or only the handle.

Vibration, together with the guard, allows the user to achieve a “5 o'clock shadow” shave or a “stubble” shave depending on rib thickness, while increasing the speed the shave is achieved while cutting the hair in half in a more efficient manner.

The user manually pulls the razor across the skin which also helps control the pressure being applied to the skin and avoiding “bald spots”.

The embodiments discussed above are illustrative only. Various other embodiments are encompassed by and contemplated by the disclosure and the appended claims.

1. A razor blade assembly with a vibration feature comprising:
a head comprising a blade assembly comprising one or more cutting blades connected to a handle;
wherein said head comprises a spacer to space said one or more cutting blades from an associated user's skin and to create and maintain a 5 o'clock shadow beard in the range of 0.1 mm to 0.4 mm in thickness;
wherein said handle houses a vibration assembly to cause vibration of at least one of said head and said handle; and a motor for operating said vibration assembly.

2. The razor blade assembly of claim 1, wherein said handle further comprises an activator button which selectively powers said motor to cause said vibration assembly to spin thus causing vibration.

3. The razor blade assembly of claim 2, wherein said vibration assembly comprises a first vibration member which spins during operation and a second vibration member which is in contact with said head.

4. The razor blade assembly of claim 3, wherein said first vibration member contacts a portion of said handle thereby said vibrating said handle.

5. The razor blade assembly of claim 1, wherein said spacer comprises a cap which is adapted to space cutting edges of said blades from the associated user's skin.

6. The razor blade assembly of claim 5, wherein said cap is removably attached onto said head.

7. The razor blade assembly of claim 6, wherein said cap comprises a first side wall, a second side wall, a top wall and a bottom wall, wherein said side walls are parallel to each other and said top and bottom walls are perpendicular to said side walls.

8. The razor blade assembly of claim 7, wherein said cap further comprises a plurality of ribs extended between said top wall and said bottom wall wherein said ribs space said blades from an associated surface to the shaved.

9. The razor blade assembly of claim 8, wherein said cap is tapered between said top wall and said bottom wall.

10. The razor blade assembly of claim 5, wherein said cap comprises a first member and a second member hingedly connected to said first member.

11. The razor blade assembly of claim 8, wherein said ribs have a thickness in the range of 0.1 mm to 0.4 mm and are adapted to create and maintain a beard thickness in a range of 0.1 mm to 0.4 mm.

12. The razor blade assembly of claim 8, wherein said ribs have a thickness in the range of 0.45 mm to 1.25 mm and are adapted to create and maintain a beard thickness in a range of 0.45 mm to 1.25 mm.

13. A method of creating and maintaining a shave appearance on the skin of a user using vibration; comprising the steps of:
providing a manual razor blade assembly having a head comprising blades;
providing a spacer which is mounted to and positioned over said head to space said blades from said skin to create and maintain a 5 o'clock shadow shave appearance in the range of 0.1 mm thickness to 0.4 mm thickness; and
providing a handle having a vibration mechanism housed therein for providing vibration to at least one of said head and said handle.

14. The method of claim 13, wherein said spacer comprises a first side wall, a second side wall, a rear wall and a front wall, wherein said side walls are parallel to each other and said rear and front walls are parallel to each other.

15. The method of claim 14, wherein said spacer further comprises a plurality of ribs extended between said rear wall and said front wall wherein said ribs space cutting edges of said blades from and the skin of the user.

16. The method of claim 15, wherein said ribs have a thickness in the range of 0.1 mm to 0.4 mm.

17. The method of claim 15, wherein said ribs have a thickness of 0.45 mm to 1.25 mm.

18. The method of claim 13, wherein said spacer is hingedly mounted to said head.

19. The method of claim 13, wherein said vibrating mechanism comprises a first vibrating member which is operated by a motor actuated by a switch wherein said first vibrating member rotates thereby vibrating said handle.

20. The method of claim 19, wherein said vibrating mechanism comprises a second vibrating member connected to said first vibrating member which contacts said head thereby vibrating said head.
